(19) United States
(12) Patent Application Publication
(10) Pub. No.: US 2008/0188219 A1
(43) Pub. Date: Aug. 7, 2008

(54) USE OF DEDICATED RACH SIGNATURES

(75) Inventor: Patrick Fischer, Bourg la Reine (FR)

Correspondence Address: LEE, HONG, DEGERMAN, KANG & SCHMADEKA, 660 S. FIGUEROA STREET, Suite 2300, LOS ANGELES, CA, 90017, US

(73) Assignee: LG Electronics Inc.

(21) Appl. No.: 11/963,652

(22) Filed: Dec. 21, 2007

Related U.S. Application Data
(60) Provisional application No. 60/888,518, filed on Feb. 6, 2007.

(51) Int. Cl. H04Q 7/22

(52) U.S. Cl. 455/434

(57) ABSTRACT

A method and apparatus for using dedicated signatures for an initial access procedure is provided for different cases in order to prevent contention due to several users sending the same signature. The present invention is applicable to a RACH initial access procedure performed when synchronizing uplink timing either periodically or upon reception of downlink data or when performing handover.

### CROSS-REFERENCE TO RELATED APPLICATIONS

Pursuant to 35 U.S.C. § 120, this application claims the benefit of U.S. Provisional Application Ser. No. 60/888,518 filed on Feb. 6, 2007, the contents of which is hereby incorporated by reference herein in its entirety.

### FIELD OF THE INVENTION

The present invention is directed to an initial access procedure in a mobile terminal using a Random Access Channel (RACH), and specifically, to a method and apparatus for using dedicated signatures for the procedure for different cases in order to prevent contention due to several users sending the same signature. The present invention is applicable to a RACH initial access procedure performed when synchronizing uplink timing either periodically or upon reception of downlink data or when performing handover.

### DESCRIPTION OF THE RELATED ART

Universal mobile telecommunications system (UMTS) is a 3rd Generation (3G) asynchronous mobile communication system operating in wideband code division multiple access (WCDMA) based on European systems, global system for mobile communications (GSM) and general packet radio services (GPRS). The long-term evolution (LTE) of UMTS is under discussion by the 3rd generation partnership project (3GPP) that standardized UMTS.

The 3GPP LTE is a technology for enabling high-speed packet communications. Many schemes have been proposed for the LTE objective including those that aim to reduce user and provider costs, improve service quality, and expand and improve coverage and system capacity. The 3G LTE requires reduced cost per bit, increased service availability, flexible use of a frequency band, a simple structure, an open interface, and adequate power consumption of a terminal as an upper-level requirement.

FIG. 1 is a block diagram illustrating network structure of an evolved universal mobile telecommunication system (E-UMTS). The E-UMTS may be also referred to as an LTE system. The communication network is widely deployed to provide a variety of communication services such as voice and packet data.

As illustrated in FIG. 1, the E-UMTS network includes an evolved UMTS terrestrial radio access network (E-UTRAN), an Evolved Packet Core (EPC) and one or more user equipment. The E-UTRAN may include one or more evolved NodeB (eNodeB) 20, and a plurality of user equipment (UE) 10 may be located in one cell. One or more E-UTRAN mobility management entity (MME)/system architecture evolution (SAE) gateways 30 may be positioned at the end of the network and connected to an external network.

As used herein, “downlink” refers to communication from eNodeB 20 to UE 10, and “uplink” refers to communication from the UE to an eNodeB. UE 10 refers to communication equipment carried by a user and may be also be referred to as a mobile station (MS), a user terminal (UT), a subscriber station (SS) or a wireless device.

An eNodeB 20 provides end points of a user plane and a control plane to the UE 10. MME/SAE gateway 30 provides an end point of a session and mobility management function for UE 10. The eNodeB and MME/SAE gateway may be connected via an S1 interface.

The eNodeB 20 is generally a fixed station that communicates with a UE 10, and may also be referred to as a base station (BS) or an access point. One eNodeB 20 may be deployed per cell. An interface for transmitting user traffic or control traffic may be used between eNodeBs 20.

The MME provides various functions including distribution of paging messages to eNodeBs 20, security control, idle state mobility control, SAE bearer control, and ciphering and integrity protection of non-access stratum (NAS) signaling. The SAE gateway host provides assorted functions including termination of U-plane packets for paging reasons, and switching of the U-plane to support UE mobility. For clarity MME/SAE gateway 30 will be referred to herein simply as a “gateway,” but it is understood that this entity includes both an MME and an SAE gateway.

A plurality of nodes may be connected between eNodeB 20 and gateway 30 via the S1 interface. The eNodeBs 20 may be connected to each other via an X2 interface and neighboring eNodeBs may have a meshed network structure that has the X2 interface.

FIG. 2 is a block diagram depicting the architecture of a typical E-UTRAN and a typical EPC. As illustrated, eNodeB 20 may perform functions of selection for gateway 30, routing toward the gateway during a Radio Resource Control (RRC) activation, scheduling and transmitting of paging messages, scheduling and transmitting of Broadcast Channel (BCCH) information, dynamic allocation of resources to UEs 10 in both uplink and downlink, configuration and provisioning of eNodeB measurements, radio bearer control, radio admission control (RAC), and connection mobility control in LTE_ACTIVE state. In the EPC, and as noted above, gateway 30 may perform functions of paging origination, LTE-IDLE state management, System Architecture Evolution (SAE) bearer control, and ciphering and integrity protection of Non-Access Stratum (NAS) signaling.

FIGS. 3(a) and 3(b) are block diagrams depicting the user-plane protocol and the control-plane protocol stack for the E-UMTS. As illustrated, the protocol layers may be divided into a first layer (L1), a second layer (L2) and a third layer (L3) based upon the three lower layers of an open system interconnection (OSI) standard model that is well known in the art of communication systems.

The physical layer, the first layer (L1), provides an information transmission service to an upper layer by using a physical channel. The physical layer is connected with a medium access control (MAC) layer located at a higher level through a transport channel, and data between the MAC layer and the physical layer is transferred via the transport channel. Between different physical layers, namely, between physical layers of a transmission side and a reception side, data is transferred via the physical channel.

The MAC layer of Layer 2 (L2) provides services to a radio link control (RLC) layer (which is a higher layer) via a logical channel. The RLC layer of Layer 2 (L2) supports the transmission of data with reliability. It should be noted that the RLC layer illustrated in FIGS. 3(a) and 3(b) is depicted because if the RLC functions are implemented in and performed by the MAC layer, the RLC layer itself is not required. The PDCP layer of Layer 2 (L2) performs a header compression function that reduces unnecessary control information such that data being transmitted by employing Internet protocol (IP) packets, such as IPv4 or IPv6, can be efficiently sent over a radio (wireless) interface that has a relatively small bandwidth.

A radio resource control (RRC) layer located at the lowest portion of the third layer (L3) is only defined in the control plane and controls logical channels, transport channels and the physical channels in relation to the configuration, reconfiguration, and release of the radio bearers (RBs). Here, the RB signifies a service provided by the second layer (L2) for data transmission between the terminal and the UTRAN.

As illustrated in FIG. 3(a), the RLC and MAC layers (terminated in an eNodeB 20 on the network side) may perform functions such as Scheduling, Automatic Repeat Request (ARQ), and Hybrid Automatic Repeat Request (HARQ). The PDCP layer (terminated in eNodeB 20 on the network side) may perform the user plane functions such as header compression, integrity protection, and ciphering.

As illustrated in FIG. 3(b), the RLC and MAC layers (terminated in an eNodeB 20 on the network side) perform the same functions as for the control plane. As illustrated, the RRC layer (terminated in an eNodeB 20 on the network side) may perform functions such as broadcasting, paging, RRC connection management, Radio Bearer (RB) control, mobility functions, and UE measurement reporting and controlling. The NAS control protocol (terminated in the MME of gateway 30 on the network side) may perform functions such as a SAE bearer management, authentication, LTE_IDLE mobility handling, paging origination in LTE_IDLE, and security control for the signaling between the gateway and UE 10.

The NAS control protocol may use three different states; first, a LTE_DETACHED state if there is no RRC entity; second, a LTE_IDLE state if there is no RRC connection while storing minimal UE information; and third, an LTE_ACTIVE state if the RRC connection is established. Also, the RRC state may be divided into two different states such as a RRC_IDLE and a RRC_CONNECTED.

In RRC_IDLE state, the UE 10 may receive broadcasts of system information and paging information while the UE specifies a Discontinuous Reception (DRX) configured by NAS, and the UE has been allocated an identification (ID) which uniquely identifies the UE in a tracking area. Also, in RRC-IDLE state, no RRC context is stored in the eNodeB.

In RRC_CONNECTED state, the UE 10 has an E-UTRAN RRC connection and a context in the E-UTRAN, such that transmitting and/or receiving data to/from the network (eNodeB) becomes possible. Also, the UE 10 can report channel quality information and feedback information to the eNodeB.

In RRC_CONNECTED state, the E-UTRAN knows the cell to which the UE 10 belongs. Therefore, the network can transmit and/or receive data to/from UE 10, the network can control mobility (handover) of the UE, and the network can perform cell measurements for a neighboring cell.

In RRC_IDLE mode, the UE 10 specifies the paging DRX (Discontinuous Reception) cycle. Specifically, the UE 10 monitors a paging signal at a specific paging occasion of every UE specific paging DRX cycle.

The paging occasion is a time interval during which a paging signal is transmitted. The UE 10 has its own paging occasion.

A paging message is transmitted over all cells belonging to the same tracking area. If the UE 10 moves from one tracking area to another tracking area, the UE will send a tracking area update message to the network to update its location.

A physical channel transfers signaling and data between layer L1 of a UE and eNB. As illustrated in FIG. 4, the physical channel transfers the signaling and data with a radio resource, which consists of one or more sub-carriers in frequency and one more symbols in time.

One sub-frame, which is 1.0 ms. in length, consists of several symbols. The particular symbol(s) of the sub-frame, such as the first symbol of the sub-frame, can be used for the L1/L2 control channel. The L1/L2 control channel carries L1/L2 control information, such as signaling.

A transport channel transfers signaling and data between the L1 and MAC layers. A physical channel is mapped to a transport channel.

Downlink transport channel types include a Broadcast Channel (BCH), a Downlink Shared Channel (DL-SCH), a Paging Channel (PCH) and a Multicast Channel (MCH). The BCH is used for transmitting system information. The DL-SCH supports HARQ, dynamic link adaptation by varying the modulation, coding and transmit power, and both dynamic and semi-static resource allocation. The DL-SCH also may enable broadcast in the entire cell and the use of beamforming. The PCH is used for paging a UE. The MCH is used for multicast or broadcast service transmission.

Uplink transport channel types include an Uplink Shared Channel (UL-SCH) and Random Access Channel(s) (RACH). The UL-SCH supports HARQ and dynamic link adaptation by varying the transmit power and potentially modulation and coding. The UL-SCH also may enable the use of beamforming. The RACH is normally used for initial access to a cell.

The MAC sublayer provides data transfer services on logical channels. A set of logical channel types is defined for different data transfer services offered by MAC. Each logical channel type is defined according to the type of information transferred.

Logical channels are generally classified into two groups. The two groups are control channels for the transfer of control plane information and traffic channels for the transfer of user plane information.

Control channels are used for transfer of control plane information only. The control channels provided by MAC include a Broadcast Control Channel (BCCH), a Paging Control Channel (PCCH), a Common Control Channel (CCCH), a Multicast Control Channel (MCCH) and a Dedicated Control Channel (DCCH). The BCCH is a downlink channel for broadcasting system control information. The PCCH is a downlink channel that transfers paging information and is used when the network does not know the location cell of a UE. The CCCH is used by UEs having no RRC connection with the network. The MCCH is a point-to-multipoint downlink channel used for transmitting MBMS control information from the network to a UE. The DCCH is a point-to-point bi-directional channel used by UEs having an RRC connection that transmits dedicated control information between a UE and the network.

Traffic channels are used for the transfer of user plane information only. The traffic channels provided by MAC include a Dedicated Traffic Channel (DTCH) and a Multicast Traffic Channel (MTCH). The DTCH is a point-to-point channel, dedicated to one UE for the transfer of user information and can exist in both uplink and downlink. The MTCH is a point-to-multipoint downlink channel for transmitting traffic data from the network to the UE.

Uplink connections between logical channels and transport channels include a DCCH that can be mapped to UL-SCH and a DTCH that can be mapped to UL-SCH. Downlink connections between logical channels and transport channels include a BCCH that can be mapped to BCH, a PCCH that can be mapped to PCH, a DCCH that can be mapped to DL-SCH, and a DTCH that can be mapped to DL-SCH.

FIG. 5 illustrates different messages exchanged between a UE 10 and eNodeB 20 during the conventional initial access procedure when a UE wishes to access the network and determines a message is to be transmitted, such as when handover is performed. As illustrated in FIG. 5, the UE 10 sends a Random Access Preamble (message 1) to the eNodeB 20 and receives Random Access Response (message 2). The Random Access Response is sent on a DL-SCH channel using a Random Access Radio Network Temporary Identifier (RA-RNTI) and includes Timing Advance (TA) value and uplink resources such as power, timing/frequency and control information. The UE 10 then transmits a scheduled message (message 3) using a quasi-unique global identification and contention resolution is performed (message 4).

A dedicated signature may be used for the random access preamble (message 1). The UE 10 must already be known to the eNodeB 20 if a dedicated signature is used. Furthermore, all UEs 10 that have attempted to access the network will read the Random Access Response (message 2) sent using the RA-RNTI, which will reflect the dedicated signature. A UE 10 will discard the Random Access Response (message 2) if the reflected signature does not match the dedicated signature used by that UE.

A source eNodeB 20 will contact the target eNode in order to reserve signatures and the associated time and frequency resources for the purpose of the handover. The target eNodeB 20 can also allocate a Cell Radio Network Temporary Identifier (C-RNTI) for the UE 10 at the same time in order to speed up the restart of normal traffic after the handover. The target eNodeB 20 will then send the handover command to the UE 10 in order to indicate the dedicated signatures and the associated time frequency resources as well as the C-RNTI.

A UE 10 that has established a connection in a cell already has a C-RNTI allocated when the UE receives the information related to the dedicated signature and the time frequency resources to be used for the transmission of the preamble for timing resynchronization. However the eNodeB 20 in the conventional access procedure has no prior knowledge regarding the C-RNTI associated with the preamble because the UE 10 selects a random preamble. Therefore an RA-RNTI is used for the Random Access Response (message 2) in order to transmit the necessary TA value.

Therefore, the conventional access procedure requires that contention resolution is performed (message 4) as well as the scheduled message (message 3) using a quasi-unique global identification that can be used to resolve the contention using message 4. Furthermore, a step (message 0) prior to sending the Random Access Preamble (message 1) is required in order to provide the UE 10 with the information regarding the C-RNTI as well as the signatures and the associated time and frequency resources to be used when a dedicated signature is used if the UE has no C-RNTI in the cell for which the timing advance must be determined,

### SUMMARY OF THE INVENTION

Additional features and advantages of the invention will be set forth in the description which follows, and in part will be apparent from the description, or may be learned by practice of the invention. It is to be understood that both the foregoing general description and the following detailed description of the present invention are exemplary and explanatory and are intended to provide further explanation of the invention as claimed.

In one aspect of the present invention, a method of establishing a communication link between a mobile terminal and a network is provided. The method includes receiving an indication of a dedicated signature for accessing the network, receiving an indication of a cell-specific mobile terminal identifier, requesting access to the network using the dedicated signature, and receiving a response acknowledging receipt of the access request and including resources for accessing the network, the response addressed using the cell-specific mobile terminal identifier.

It is contemplated that the method further includes transmitting data using the resources. It is further contemplated that the indication of the dedicated signature for accessing the network and the indication of the cell-specific mobile terminal identifier are received in the same message.

It is contemplated that the cell-specific mobile terminal identifier includes a C-RNTI. It is further contemplated that the access request is transmitted over a Random Access Channel and the response is received over a Downlink Shared Channel.

It is contemplated that receiving an indication of a cell-specific mobile terminal identifier includes receiving a message including the cell-specific mobile terminal identifier. It is further contemplated that receiving the indication of the dedicated signature further includes receiving information regarding conditions for use of the dedicated signature by a mobile terminal for requesting access to the network.

In another aspect of the present invention, a method of establishing a communication link between a mobile terminal and a network is provided. The method includes providing an indication of a dedicated signature for accessing the network and a cell-specific mobile terminal identifier, receiving a request for access to the network using the dedicated signature, and transmitting a response acknowledging receipt of the access request and including resources for accessing the network, the response addressed using the cell-specific mobile terminal identifier.

It is contemplated that the dedicated signature for accessing the network and the permanent mobile communication terminal identifier are transmitted in the same message. It is further contemplated that the permanent terminal identifier is a C-RNTI, the request for access to the network is a random access request message and the response is a random access response message.

It is contemplated the method further includes receiving data transmitted using the resources. It is further contemplated that the dedicated signature, permanent terminal identifier, and response are transmitted over a Random Access Channel and the request for access and the data are received over the Random Access Channel.

In another aspect of the present invention, a mobile terminal for of establishing a communication link with a network is provided. The mobile terminal includes a transmitting/receiving unit transmitting and receiving messages between the mobile terminal and the network, a display unit displaying user interface information, an input unit receiving inputs from a user and a processing unit processing an indication of a dedicated signature for accessing the network and an indication of a cell-specific mobile terminal identifier, controlling the transmitting/receiving unit to request access to the network using the dedicated signature, and processing a response received from the network and addressed using the cell-specific mobile terminal identifier, wherein the response acknowledges receipt of the access request and includes resources for accessing the network.

It is contemplated that the processing unit further controls the transmitting/receiving unit to transmit data using the resources. It is further contemplated that the processing unit processes the indication of the dedicated signature for accessing the network and the indication of the cell-specific mobile terminal identifier from the same received message.

It is contemplated that the cell-specific mobile terminal identifier is a C-RNTI. It is further contemplated that the processing unit controls the transmitting/receiving unit to transmit the access request over a Random Access Channel and to receive the response over a Downlink Shared Channel.

It is contemplated that the processing unit processes the indication of the cell-specific mobile terminal identifier from a received message including the cell-specific mobile terminal identifier. It is further contemplated that the processing unit processes the indication of the dedicated signature from information regarding conditions for use of the dedicated signature by a mobile terminal for requesting access to the network

In another aspect of the present invention, a network for establishing a communication link with a mobile terminal is provided. The network includes a transmitter transmitting messages to the mobile terminal, a receiver receiving messages from the mobile terminal and a controller controlling the transmitter to provide an indication of a dedicated signature for accessing the network and a cell-specific mobile terminal identifier, processing a request for access to the network using the dedicated signature, and controlling the transmitter to transmit a response addressed using the cell-specific mobile terminal identifier, wherein the response acknowledges receipt of the access request and includes resources for accessing the network.

It is contemplated that the controller controls the transmitter to transmit the dedicated signature for accessing the network and the permanent mobile communication terminal identifier in the same message. It is further contemplated that the permanent terminal identifier is a C-RNTI, the request for access to the network is a random access request message and the response is a random access response message.

It is contemplated that the controller further processes data transmitted using the resources. It is further contemplated that controller controls the transmitter to transmit the dedicated signature, permanent terminal identifier, and response over a Random Access Channel and processes the request for access and the data from messages received over the Random Access Channel.

These and other embodiments will also become readily apparent to those skilled in the art from the following detailed description of the embodiments having reference to the attached figures, the invention not being limited to any particular embodiments disclosed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. Features, elements, and aspects of the invention that are referenced by the same numerals in different figures represent the same, equivalent, or similar features, elements, or aspects in accordance with one or more embodiments.

FIG. 1 illustrates a block diagram illustrating network structure of an evolved universal mobile telecommunication system (E-UMTS).

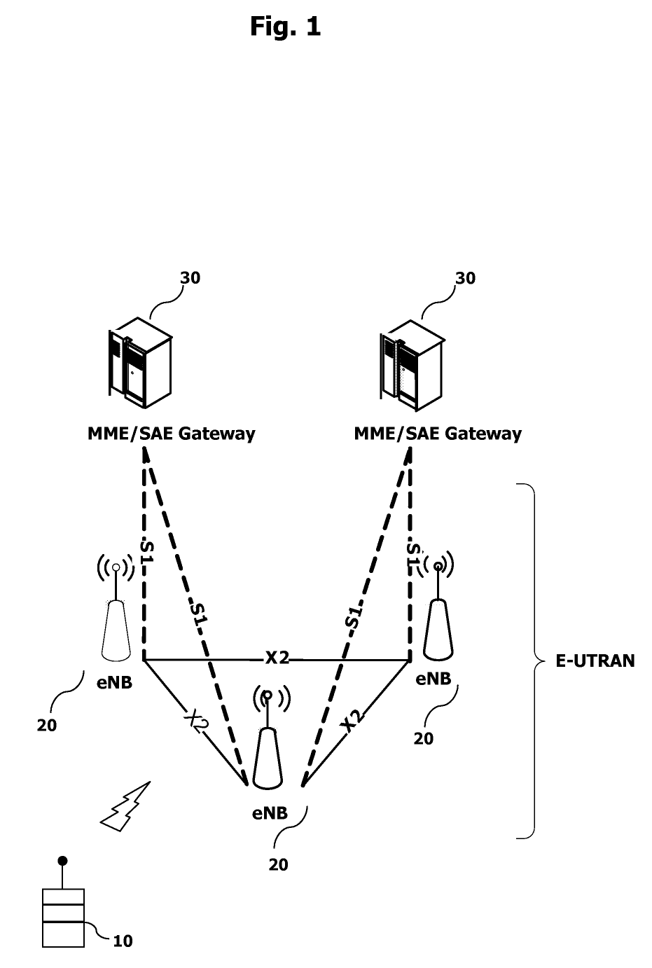

FIG. 2 illustrates a block diagram depicting architecture of a typical E-UTRAN and a typical evolved packet core (EPC).

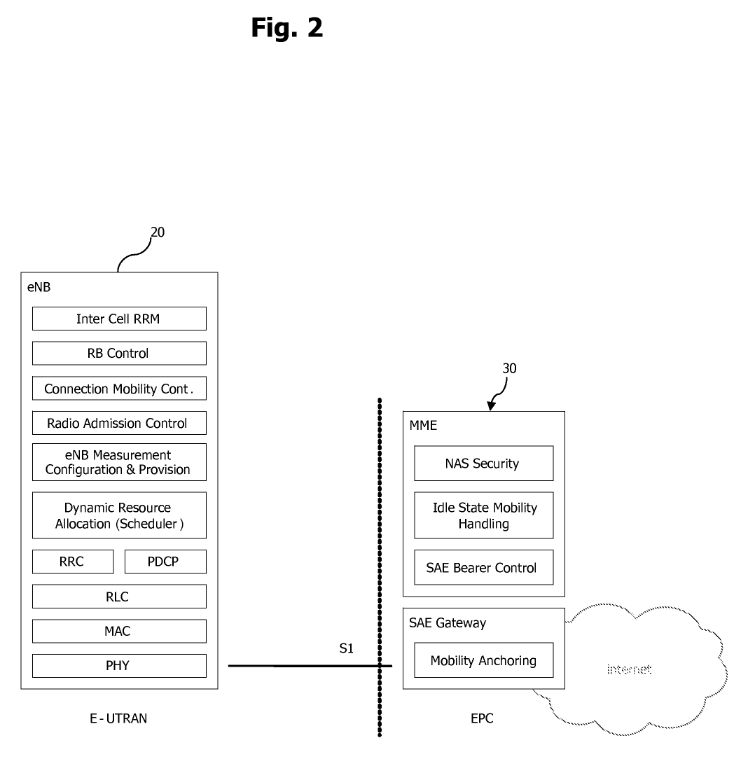

FIG. 3(a) illustrates the user-plane protocol for the E-UMTS.

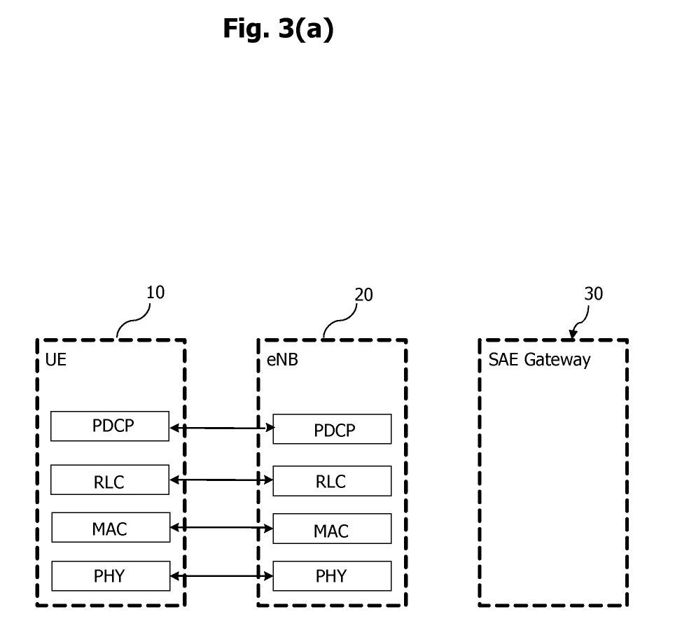

FIG. 3(a) illustrates the control-plane protocol stack for the E-UMTS

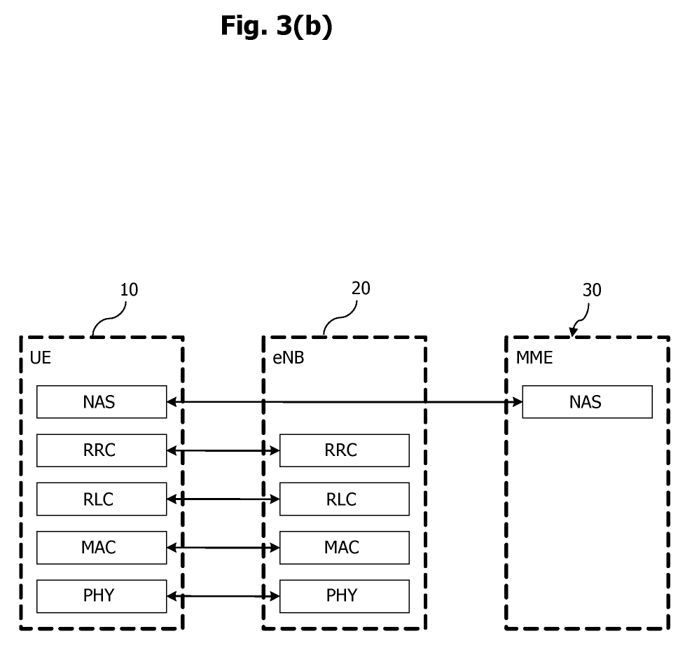

FIG. 4 illustrates a Structure of the physical channel.

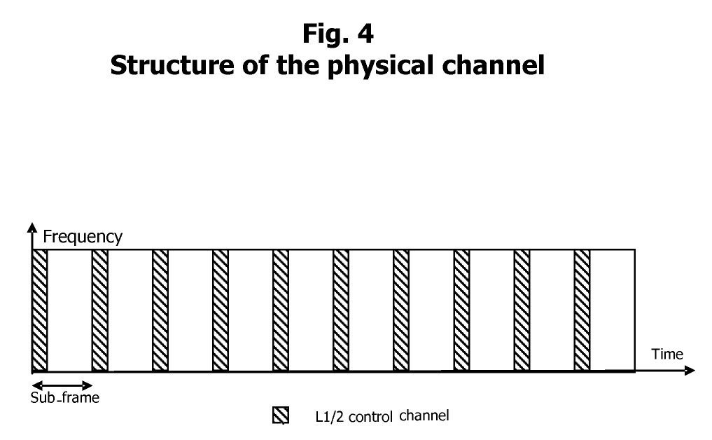

FIG. 5 illustrates a Random Access procedure for E-UTRAN initial access.

FIG. 6 illustrates a random access procedure according to the present invention.

FIG. 7 illustrates a block diagram of a mobile station (MS) or access terminal (AT) according to the present invention.

### DETAILED DESCRIPTION OF THE PREFERRED EMBODIMENTS

Reference will now be made in detail to the preferred embodiments of the present invention, examples of which are illustrated in the accompanying drawings. The present invention is directed to a RACH initial access procedure in a UE 10.

The present invention proposes to use dedicated signatures when performing a random access procedure and, specifically, using the already allocated C-RNTI for the transmission of the response message (message 2), including the timing advance (TA) and reserved uplink resources, that is sent in response to the preamble (message 1) sent by a UE 10.

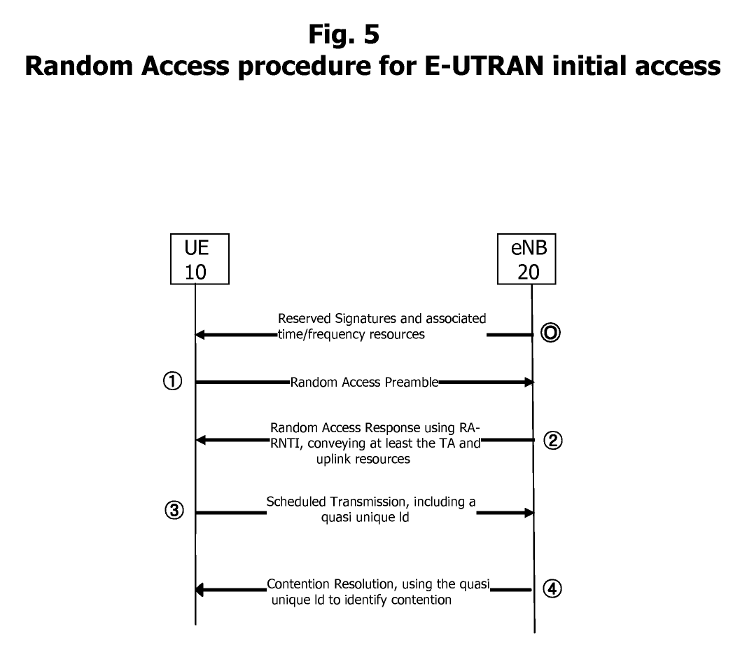

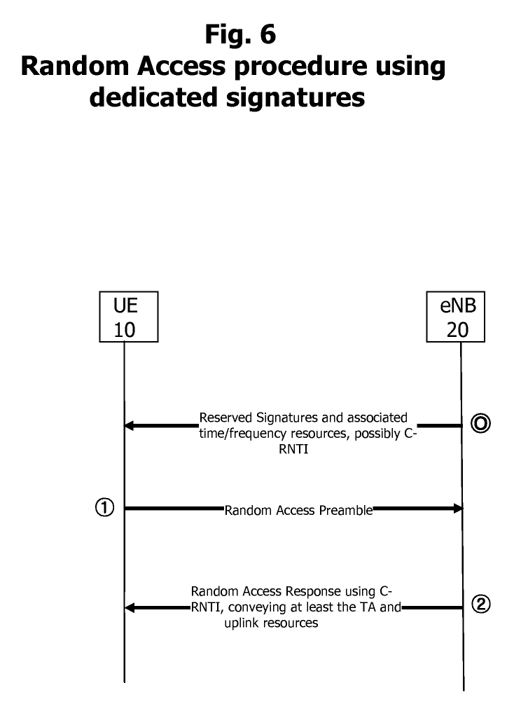

The present invention proposes to eliminate the contention resolution procedure (messages 3 and 4) illustrated in FIG. 5 since signatures and associated time and frequency resources are reserved for one unique UE 10 for which the C-RNTI is already allocated and known to the eNodeB 20. The proposed procedure of dedicated access is shown in FIG. 6.

As illustrated in FIG. 6, the eNodeB 20 indicates the reserved signatures and associated time and frequency resources to the UE 10 (message 0) as well as a C-RNTI if no C-RNTI has already been allocated to the UE. Therefore, the source eNodeB 20 may need to have previously contacted the target eNodeB such that the target eNodeB can reserve a signatures and a C-RNTI for the UE 10.

The UE 10 sends the Random Access Preamble (message 0) using the previously allocated resources. The eNodeB 20 then transmits the TA value and possibly uplink resource reservations to the UE 10 using the dedicated C-RNTI for the Random Access Response (message 2), an improvement over the conventional random access procedure illustrated in FIG. 5. It is contemplated to use HARQ for the transmission of the Random Access Response (message 2).

The present invention allows only the specific UE 10 to which the C-RNTI was assigned to read the Random Access Response (message 2). Therefore, the Random Access Response (message 2) can be a regular Access Stratum (AS) signaling message that is sent with a lower power based on a specific UE and possibly including other UE-specific information, an improvement over the conventional Random Access Response (message 2) transmitted using the RA-RNTI. The present invention also facilitates sharing the RACH resources used for real random access and contention-free access using dedicated reserved signatures.

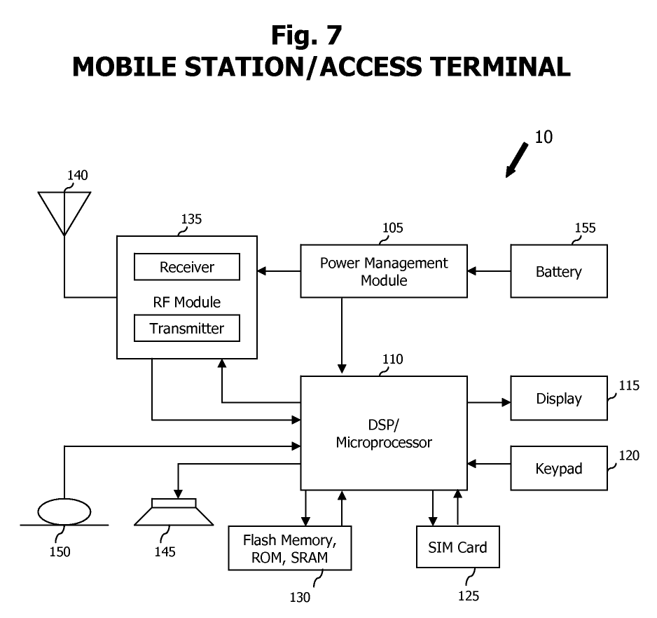

FIG. 7 illustrates a block diagram of a mobile station (MS) or User Equipment (UE) 10. The UE 10 includes a processor (or digital signal processor) 110, RF module 135, power management module 105, antenna 140, battery 155, display 115, keypad 120, memory 130, SIM card 125 (which may be optional), speaker 145 and microphone 150.

A user enters instructional information, such as a telephone number, for example, by pushing the buttons of a keypad 120 or by voice activation using the microphone 150. The microprocessor 110 receives and processes the instructional information to perform the appropriate function, such as to dial the telephone number. Operational data may be retrieved from the Subscriber Identity Module (SIM) card 125 or the memory module 130 to perform the function. Furthermore, the processor 110 may display the instructional and operational information on the display 115 for the user's reference and convenience.

The processor 110 issues instructional information to the RF module 135, to initiate communication, for example, transmits radio signals comprising voice communication data. The RF module 135 comprises a receiver and a transmitter to receive and transmit radio signals. An antenna 140 facilitates the transmission and reception of radio signals. Upon receiving radio signals, the RF module 135 may forward and convert the signals to baseband frequency for processing by the processor 110. The processed signals would be transformed into audible or readable information outputted via the speaker 145, for example. The processor 110 also includes the protocols and functions necessary to perform the various processes described herein.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims. Therefore, all changes and modifications that fall within the metes and bounds of the claims, or equivalence of such metes and bounds are intended to be embraced by the appended claims.

The foregoing embodiments and advantages are merely exemplary and are not to be construed as limiting the present invention. The present teaching can be readily applied to other types of apparatuses.

The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

What is claimed is:

1. A method of establishing a communication link between a mobile terminal and a network, the method comprising:
receiving an indication of a dedicated signature for accessing the network;
receiving an indication of a cell-specific mobile terminal identifier;
requesting access to the network using the dedicated signature; and
receiving a response acknowledging receipt of the access request and comprising resources for accessing the network, the response addressed using the cell-specific mobile terminal identifier.

2. The method of claim 1, further comprising:
transmitting data using the resources.

3. The method of claim 1, wherein the indication of the dedicated signature for accessing the network and the indication of the cell-specific mobile terminal identifier are received in the same message.

4. The method of claim 1, wherein the cell-specific mobile terminal identifier comprises a C-RNTI.

5. The method of claim 1, wherein the access request is transmitted over a Random Access Channel and the response is received over a Downlink Shared Channel.

6. The method of claim 1, wherein receiving an indication of a cell-specific mobile terminal identifier comprises receiving a message including the cell-specific mobile terminal identifier.

7. The method of claim 1, wherein receiving the indication of the dedicated signature further comprises receiving information regarding conditions for use of the dedicated signature by a mobile terminal for requesting access to the network.

8. A method of establishing a communication link between a mobile terminal and a network, the method comprising:
providing an indication of a dedicated signature for accessing the network and a cell-specific mobile terminal identifier;
receiving a request for access to the network using the dedicated signature; and
transmitting a response acknowledging receipt of the access request and comprising resources for accessing the network, the response addressed using the cell-specific mobile terminal identifier.

9. The method of claim 8, wherein the dedicated signature for accessing the network and the permanent mobile communication terminal identifier are transmitted in the same message.

10. The method of claim 8, wherein the permanent terminal identifier comprises a C-RNTI, the request for access to the network comprises a random access request message and the response comprises a random access response message.

11. The method of claim 8, further comprising:
receiving data transmitted using the resources.

12. The method of claim 8, wherein the dedicated signature, permanent terminal identifier, and response are transmitted over a Random Access Channel and the request for access and the data are received over the Random Access Channel.

13. A mobile terminal for of establishing a communication link with a network, the mobile terminal comprising:
a transmitting/receiving unit transmitting and receiving messages between the mobile terminal and the network;
a display unit displaying user interface information;
an input unit receiving inputs from a user; and
a processing unit processing an indication of a dedicated signature for accessing the network and an indication of a cell-specific mobile terminal identifier, controlling the transmitting/receiving unit to request access to the network using the dedicated signature, and processing a response received from the network and addressed using the cell-specific mobile terminal identifier,
wherein the response acknowledges receipt of the access request and comprises resources for accessing the network.

14. The mobile terminal of claim 13, wherein the processing unit further controls the transmitting/receiving unit to transmit data using the resources.

15. The mobile terminal of claim 13, wherein the processing unit processes the indication of the dedicated signature for accessing the network and the indication of the cell-specific mobile terminal identifier from the same received message.

16. The mobile terminal of claim 13, wherein the cell-specific mobile terminal identifier comprises a C-RNTI.

17. The mobile terminal of claim 13, wherein the processing unit controls the transmitting/receiving unit to transmit the access request over a Random Access Channel and to receive the response over a Downlink Shared Channel.

18. The mobile terminal of claim 13, wherein the processing unit processes the indication of the cell-specific mobile terminal identifier from a received message including the cell-specific mobile terminal identifier.

19. The mobile terminal of claim 13, wherein the processing unit processes the indication of the dedicated signature from information regarding conditions for use of the dedicated signature by a mobile terminal for requesting access to the network.

20. A network for establishing a communication link with a mobile terminal, the network comprising:
a transmitter transmitting messages to the mobile terminal;
a receiver receiving messages from the mobile terminal; and
a controller controlling the transmitter to provide an indication of a dedicated signature for accessing the network and a cell-specific mobile terminal identifier, processing a request for access to the network using the dedicated signature, and controlling the transmitter to transmit a response addressed using the cell-specific mobile terminal identifier,
wherein the response acknowledges receipt of the access request and comprises resources for accessing the network.

21. The network of claim 20, wherein the controller controls the transmitter to transmit the dedicated signature for accessing the network and the permanent mobile communication terminal identifier in the same message.

22. The network of claim 20 wherein the permanent terminal identifier comprises a C-RNTI, the request for access to the network comprises a random access request message and the response comprises a random access response message.

23. The network of claim 20, wherein the controller further processes data transmitted using the resources.

24. The network of claim 23, wherein controller controls the transmitter to transmit the dedicated signature, permanent terminal identifier, and response over a Random Access Channel and processes the request for access and the data from messages received over the Random Access Channel.
